(19) United States
(12) Patent Application Publication
(10) Pub. No.: US 2016/0102823 A1
(43) Pub. Date: Apr. 14, 2016

(54) LIGHT-EMITTING PANEL

(71) Applicant: KONINKLIJKE PHILIPS N.V., Eindhoven (NL)

(72) Inventors: Philip Steven NEWTON, Waalre (NL); Bartel Marinus VAN DE SLUIS, EINDHOVEN (NL); Dzmitry Viktorovich ALIAKSEYEU, EINDHOVEN (NL); Tatiana Aleksandrovna LASHINA, EINDHOVEN (NL)

(21) Appl. No.: 14/893,090

(22) PCT Filed: May 19, 2014
(86) PCT No.: PCT/EP2014/060196

§ 371 Date: Nov. 23, 2015

(30) Foreign Application Priority Data
May 23, 2013 (EP) 13168827.7

(51) Int. Cl. F21S 4/00; F21V 23/04

(52) U.S. Cl. CPC F21S 4/002; F21V 23/0457; F21Y 2101/02

(57) ABSTRACT

The present invention relates to a light-emitting panel (1) comprising a first plurality of light-sources (11a-d) arranged in a first light-source layer (12) and a second plurality of light-sources (14a-d) arranged in a second light-source layer (15), with a light-diffusing layer (13) being arranged and configured to substantially only diffuse light emitted by light-sources in the first plurality of light-sources (11a-d) so that the light-emitting panel (1) is arranged to provide diffused illumination from the first light-source layer (12) and substantially un-diffused illumination from the second light-source layer (15). The light-emitting panel (1) also comprises a light sensor for sensing light that is emitted by light-sources in the first plurality of light-sources (11a-d) following reflection at an object arranged in front of the light-emitting panel (1), so that the operation of the light-emitting panel (1) can be controlled based on the signal provided by the light-sensor.

### FIELD OF THE INVENTION

The present invention relates to a light-emitting panel.

### BACKGROUND OF THE INVENTION

In modern offices as well as city apartments, access to daylight may be limited and there may be a need for new types of illumination, such as artificial daylight.

Suitable illumination could, for example, be provided using light-emitting panels such as those disclosed by GB 2449179, in which LEDs are arranged in an array in each panel.

However, the light-emitting panels according to GB 2449179 are mainly for outdoor use and therefore do not provide for the kind of lighting that is often desired indoors, such as diffuse lighting and the possibility to spatially adapt the lighting to different conditions in the indoor space, such as different furniture configurations etc.

### SUMMARY OF THE INVENTION

In view of the above-mentioned and other drawbacks of the prior art, a general object of the present invention is to provide an improved light-emitting panel, in particular providing for pleasant and adaptable lighting.

According to a first aspect of the present invention there is provided a light-emitting panel comprising a front side and a back side. The light-emitting panel further comprises a first plurality of light-sources arranged in a first light-source layer and a second plurality of light-sources arranged in a second light-source layer. The first and second light source layers are both arranged to emit light in a direction towards the front side of the panel.

The light-emitting panel also comprises a light-diffusing layer that is arranged and configured to substantially only diffuse light emitted by light-sources in the first plurality of light-sources so that the light-emitting panel is arranged to provide diffused illumination from the first light-source layer and substantially un-diffused illumination from the second light-source layer.

The second light-source layer comprises a light-sensor for providing a signal based on the sensing of light emitted by light-sources in the first plurality of light-sources following reflection at an object arranged in front of the light-emitting panel. The light sensor is formed by at least a sub-set of the light-sources in the second plurality of light-sources that are controllable between a light-emitting state and a light-sensing state.

Finally, the light-emitting panel comprises control circuitry configured to control light-sources in the second plurality of light-sources between the light-emitting state and the light-sensing state, and to control operation of the light-emitting panel based on the signal provided by the light-sensor.

The light-sources may advantageously be solid state light-sources, which should be understood to be light-sources in which light is generated through recombination of electrons and holes. Examples of solid state light-sources include LEDs and semiconductor lasers.

When the light-diffusing layer “diffuses” the light emitted by the first plurality of light-sources, the angular distribution of the light emitted by the light-source is broadened, so that it appears to come from many directions, and not from a point source. One way of diffusing light may be to provide a large number of direction changing elements in front of the light-source to have its light diffused. The direction changing elements may, for example, be scattering and/or refracting elements, which redirect the light emitted by the light-source.

Accordingly, the light-sources in the first plurality of light-sources provide a substantially uniform illumination that is generally perceived as pleasant.

The light-sources in the second plurality of light-sources, on the other hand, are arranged to provide “substantially un-diffused” illumination. By “substantially un-diffused” should be understood that the light emitted by each light-source in the second plurality of light-sources is subjected to no or relatively few direction changes before exiting the light-emitting panel. At the very least, the light emitted by each of the light-sources in the second plurality of light-sources has been diffused considerably less than the light emitted by each of the light-sources in the first plurality of light-sources. It can therefore be said that the light-sources in the second plurality of light-sources are arranged and configured to provide directional illumination that can be used for illuminating items that should be highlighted and/or for providing workplace illumination for a desktop or the like.

The present invention is based on the realization that a pleasant uniform illumination can be achieved in combination with task lighting and/or highlighting through the provision of a layered light-emitting panel comprising two sets of light-sources and a light-diffusing layer arranged and configured to diffuse light emitting by light-sources in one of the sets of light-sources. In addition, the present inventors have realized that this configuration opens up the possibility to adapt the illumination provided by the light-emitting panel by controlling light-sources in the second plurality of light-sources to function as light-sensors in a panel calibration mode. Accordingly, various embodiments of the present invention provide for pleasant and adaptable illumination.

As was indicated above, the light-sensor is formed by at least a sub-set of the light-sources in the second plurality of light-sources that are controllable between a light-emitting state and a light-sensing state. The latter may be obtained by reversing polarity of the voltage applied to the light-sources.

By controlling operation of the light-emitting panel based on the signal from the light-sensor, the illumination provided by the light-emitting panel can be adapted to different conditions, such as different rooms and/or different configurations in the room, such as redecoration (moving furniture or adding or removing various items that may influence the illumination requirements in the room).

At least a sub-set of the light-sources in the second plurality of light-sources can together work as a kind of low-resolution camera that can provide a rudimentary image indicating the configuration of the room.

In an embodiment of the light-emitting panel, the first and second light source layers are separate layers of a stack, wherein the second light-source layer is optically transparent for light emitted by the first plurality of light-sources. In this embodiment, the light-diffusing layer is sandwiched between the first light-source layer and the second light-source layer.

In another embodiment of the light-emitting panel, each of the light-sources in the second plurality of light-sources is arranged in the first light-source layer. In this embodiment, the light-diffusing layer is arranged and configured to exhibit a higher diffuser efficiency for light emitted by light-sources in the first plurality of light-sources than for light emitted by light-sources in the second plurality of light-sources. A suitable light-diffusing layer having a spatially varying diffuser efficiency is, for example, described in U.S. Pat. No. 6,846,098.

The second light-source layer may advantageously comprise a grid-shaped substrate, and each of the light-sources in the second plurality of light-sources may be connected to the grid-shaped substrate. Such a construction can be used to provide the second light-source layer with a desired transparency.

The grid-shaped substrate may be any substrate that is “open” so that light is allowed to pass through it. The substrate could, for example, be a two-dimensional rectangular grid, or it may comprise strips extending substantially in parallel with each other.

Advantageously, the grid-shaped substrate may comprise a plurality of metal wires defining a grid with nodes; and each of the light-sources in the second plurality of light-sources may be arranged at a respective one of the nodes and electrically and mechanically connected to at least two of the metal wires. The metal wires may, furthermore, be non-crossing metal wires, which provides for convenient driving of the solid-state light sources using a small number of connectors, which further adds to the cost-efficiency of the light-emitting panel according to various embodiments of the invention.

The light-sources in the second plurality of light-sources may be individually addressable. This may, for example, be achieved by providing each light-source with local control circuitry and communicate over the substrate, such as, for example, the wire grid. Alternatively, or in combination, the second light-source layer may be provided with a separate serial bus, such as a two-wire bus, that may be provided in combination with the grid-shaped substrate.

Moreover, the second light-source layer may further comprise a transparent material, such as silicone, embedding the metal wires and the light-sources. Although silicone is specifically mentioned, it should be understood that various other suitable materials are well known to the person skilled in the art.

According to various embodiments, the light-emitting panel of the present invention may further comprise a base structure, and the first plurality of light-sources may be embedded in the base structure. Various ways of embedding light-sources in a base structure are, for example, described in U.S. Pat. No. 7,543,956. For instance, the first plurality of light-sources may be provided on a carrier, such as a grid-shaped substrate, and then the substrate with light-sources may be embedded in a suitable material that is at least partly optically transparent.

Advantageously, each light-source in the first plurality of light-sources may be embedded in a light-diffusing material forming the light-diffusing layer.

In embodiments where the light-sources in the first plurality of light-sources are attached to a wire grid type substrate, parts of the wire grid can be bent to stick out through the embedding material, to be available for powering also the light-sources in the second light-source layer.

Furthermore, each of the light-sources in the first plurality of light-sources may have a lower luminous intensity than any of the light-sources in the second plurality of light-sources.

Moreover, the light-emitting panel may further comprise a set of refractive optical elements, each being arranged in front of a corresponding one of the light-sources in the second set of light-sources.

In various embodiments where the light-emitting panel comprises control circuitry for controlling the light-emitting panel, the light-emitting panel may comprise a memory; and the control circuitry may be configured to control light-sources in the first plurality of light-sources to emit light; acquire a signal indicative of sensed light (using dedicated light-sensors and/or light-sources in the second plurality of light-sources); determine control parameters for the light-emitting panel based on the signals; and store the control parameters in the memory.

It should be noted that the control circuitry may be realized in hardware, software or a combination thereof. Furthermore, the control circuitry may be centralized or distributed. For instance, the control circuitry may include a central unit that communicates with local units that may be co-located with light-sources in the second plurality of light-sources and/or with one or several separate dedicated light-sensors.

The light-emitting panel can be controlled by a method that comprises the steps of (a) controlling the light-sources in the second plurality of light-sources to the light-sensing state, (b) emitting light from light-sources in the first plurality of light-sources, (c) acquiring a signal indicative of sensed light from each of the light-sources in the second plurality of light-sources forming the light sensor, and (d) determining control parameters for the light-emitting panel based on this signal.

According to various embodiments, light from light-sources in the first plurality of light-sources may be emitted as coded light. Hereby, the light emitted by the light-sources in the first plurality of light-sources (and the reflection of that light) will be distinguishable from light from other sources, such as ambient light. For instance, the light may be flashed according to a predetermined scheme. Examples of lighting control using coded light are provided by WO-2012/035469 and WO-2011/030292.

Further variations and advantages of this second aspect of the present invention are largely analogous to those provided above in connection with the first aspect of the invention.

### BRIEF DESCRIPTION OF THE DRAWINGS

These and other aspects of the present invention will now be described in more detail, with reference to the appended drawings showing example embodiments of the invention, wherein:

FIG. 1 schematically shows an exemplary application of the light-emitting panel according to various embodiments of the present invention, in the form of a light-emitting panel arranged on a wall;

FIG. 2 is a schematic perspective cutaway view of a first embodiment of the light-emitting panel in FIG. 1;

FIG. 3 is a schematic perspective cutaway view of a second embodiment of the light-emitting panel in FIG. 1;

FIG. 4 is a schematic block diagram of the light-emitting panel in FIG. 1; and

FIG. 5 is a flow-chart illustrating an embodiment of a method of controlling the light-emitting panel in FIG. 1.

### DETAILED DESCRIPTION OF THE EMBODIMENTS

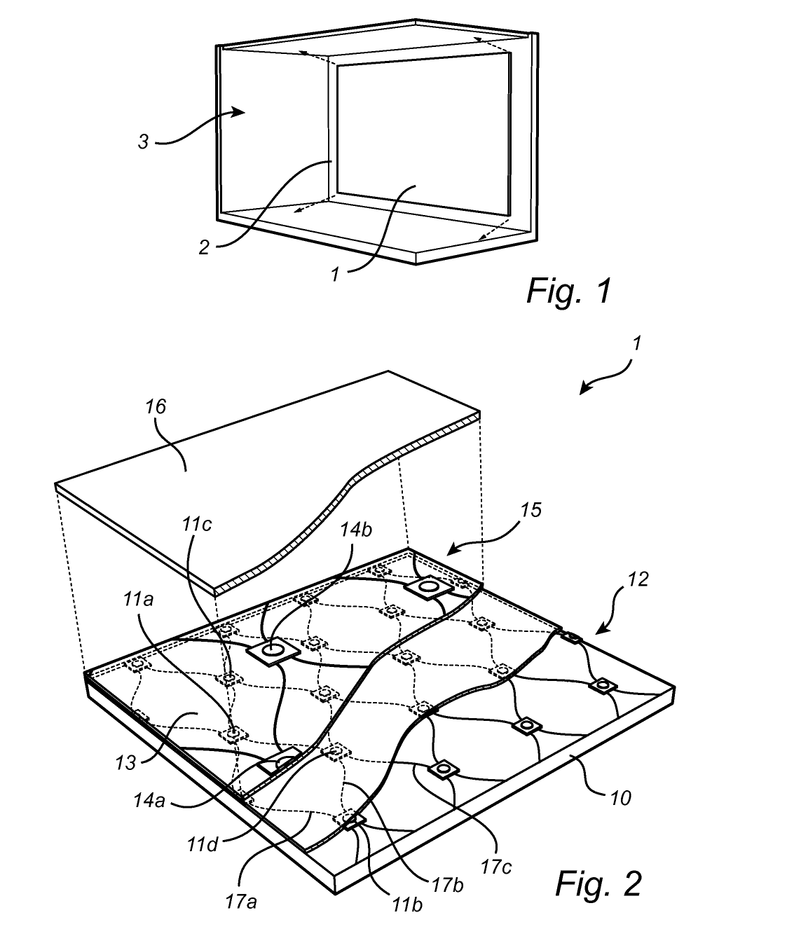

FIG. 1 schematically illustrates an exemplary application for embodiments of the light-emitting device according to the present invention, in the form of a light-emitting panel 1 arranged on a wall 2 of a room 3. The light-emitting panel 1 may be intended as daylight replacement.

With reference to FIG. 2, which is a schematic perspective cutaway view of a first embodiment of the light-emitting panel in FIG. 1, the light-emitting panel 1 comprises a base structure 10, a first plurality of light-sources 11a-d (only some of the light-sources in the first plurality of light-sources are indicated using reference numerals to avoid cluttering the drawing) in a first light-source layer 12, a light-diffusing layer 13 arranged and configured to diffuse light emitted by the light-sources 11a-b in the first plurality of light-sources, and a second plurality of light-sources 14a-b (again only two of the light-sources are indicated using reference numerals) arranged in a second light-source layer 15, so that the light-diffusing layer 13 is sandwiched between the first light-source layer 12 and the second light-source layer 15.

As is schematically illustrated in FIG. 2, the light-sources 11a-d in the first light-source layer 12 are embedded in an optically transparent material, such as silicone. Other examples of suitable embedding materials are high density polyethylene (HDP) or polycarbonate (PC).

The light-sources 14a-b in the second light-source layer 15 are also embedded in an optically transparent material 16, such as silicone.

As is schematically illustrated in FIG. 2, the light-sources 11a-d in the first light-source layer 12 are arranged in a two-dimensional light-source array, here in the form of a first LED grid.

The first LED grid is provided in the form of an open grid of metal wires 17a-c with a first set of LEDs 11a-b electrically and mechanically connected to the adjacent first 17a and second 17b metal wires and a second set of LEDs 11c-d electrically and mechanically connected to the adjacent second 17b and third 17c metal wires. Hereby, application of a voltage between, for example, the first 17a and the third 17c metal wires results in light being emitted by the LEDs 11a-b connected between the first 17a and second 17b metal wires as well as by the LEDs 11c-d connected between the second 17b and the third 17c metal wires. It should be noted that the above is a simplified description of a portion of the first LED grid, and that the LED grid, in a real application, will typically comprise several additional metal wires and a larger number of LEDs connected to adjacent ones of the metal wires. The function and realization of such an LED grid should, however, be straight-forward to those of ordinary skill in the art based on the description provided above.

In the presently illustrated embodiment, the light-sources 14a-b in the second light-source layer 15 are arranged in a second LED grid with the same basic properties as described above for the first LED grid, with the difference that the spacing between the light-sources 14a-b in the second light-source layer 15 is considerably larger than the spacing between the light-sources 11a-d in the first light-source layer 12.

Advantageously, the light-sources 11a-d in the first light-source layer 12 may be low to medium power LEDs, such as LUXEON® 3535 by Philips Lumileds, and the light-sources 14a-b in the second light-source layer 15 may be high power LEDs, such as LUXEON® Rebel, also by Philips Lumileds.

In FIG. 2, the light-diffusing layer 13 is illustrated as a separate diffusor film. Such films are available from several suppliers, and the diffusion may be achieved through scattering and/or refraction. For instance, scattering particles may be distributed in a clear base film. Another alternative is to use a plastic sheet with surface structures formed therein. So-called meso-optics may also be applied.

As an alternative to a separate diffusor film, scattering particles may be dispensed in the material used for embedding the light-sources 11a-d in the first light-source layer 12.

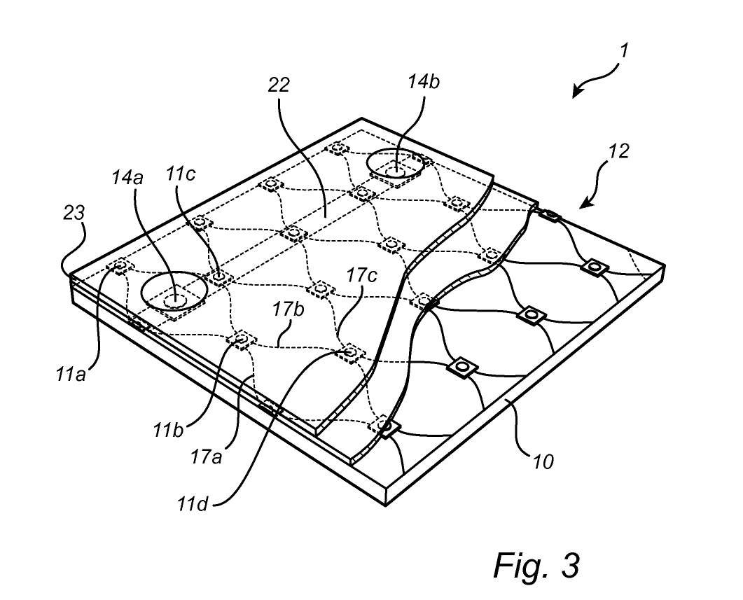

With reference to FIG. 3, which is a schematic perspective cutaway view of a second embodiment of the light-emitting panel in FIG. 1, the light-emitting panel 1 comprises a base structure 10, a first plurality of light-sources 11a-d (only some of the light-sources in the first plurality of light-sources are indicated using reference numerals to avoid cluttering the drawing) in a first light-source layer 12, a light-diffusing layer 23 arranged and configured to diffuse light emitted by the light-sources 11a-b in the first plurality of light-sources, and a second plurality of light-sources 14a-b (again only two of the light-sources are indicated using reference numerals) which are also arranged in the first light-source layer 12.

In this embodiment, the light-sources 14a-b in the second plurality of light-sources are arranged on an LED-strip 22 that may be arranged below (or above) the wires 17a-c in the first LED grid.

The light-diffusing layer 23 is here arranged and configured to exhibit a spatially varying diffuser efficiency with a higher diffuser efficiency at locations corresponding to locations for light-sources 11a-d in the first plurality of light-sources than at locations corresponding to locations for light-sources 14a-b in the second plurality of light-sources. This is schematically indicated in FIG. 3 by circles defining optically clear areas over the light-sources 14a-b in the second plurality of light-sources. The spatially varying diffuser efficiency may, for example be achieved using a spatially varying density of scattering particles, but may be provided in several other ways, for example as described in U.S. Pat. No. 6,846,098.

In various embodiments, the light-emitting panel 1 is adaptable to different configurations of the room 3 where it is installed. If, for instance, a sofa is placed in front of the light-emitting panel 1, embodiments of the light-emitting panel 1 can, upon request by a user, automatically adapt its illumination configuration to the new situation, so that the backside of the sofa is not illuminated. This saves energy and reduces the occurrence of unwanted optical phenomena, such as sharp shadows.

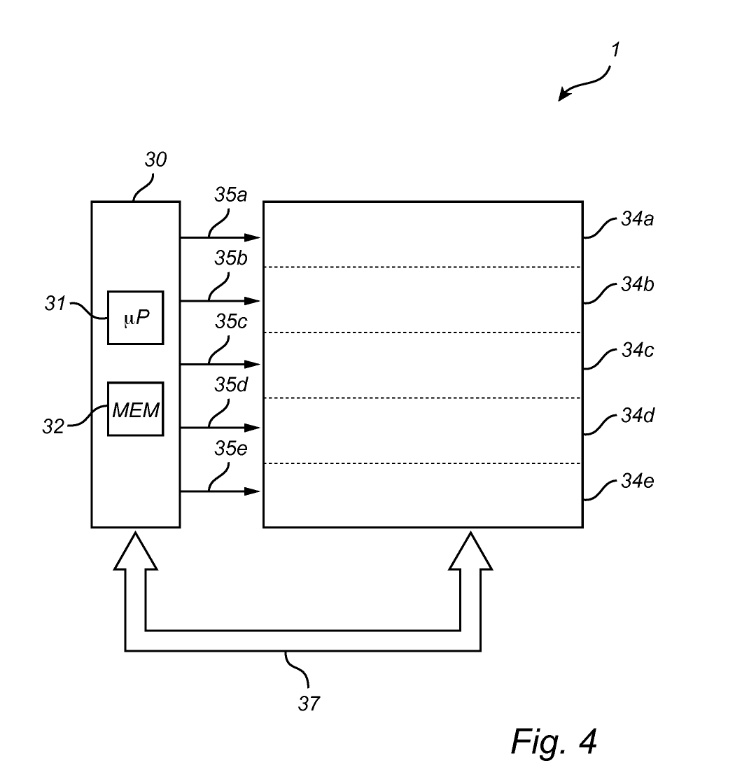

To provide for the desired adaptability, the light-emitting panel 1 may be configured, on a system level, as is schematically indicated by the block diagram in FIG. 4. In the exemplary embodiment schematically shown in FIG. 4, the light-emitting panel 1 comprises a control unit 30 with a processor 31 and memory 32 for storing control parameters for the lighting panel 1. As is schematically illustrated in FIG. 4, the light-emitting panel 1 is further functionally divided into a number of segments 34a-e. Referring also to FIG. 2 and FIG. 3, the different segments 34a-e are individually controllable in such a way that the light-sources 11a-d in the first plurality of light-sources of the different segments 34a-e can be turned on independently of each other. Accordingly, one or several of the segments 34a-e of the light-emitting panel 1 can be controlled to emit diffuse light through control by the control unit 30, as is schematically illustrated by the control lines 35a-e.

As is also shown in FIG. 4, the light-emitting panel 1 further comprises a communication bus 37 for allowing communication (control and/or read-out) with the light-sources 14a-b (referring to FIG. 2 and FIG. 3) in the second plurality of light-sources.

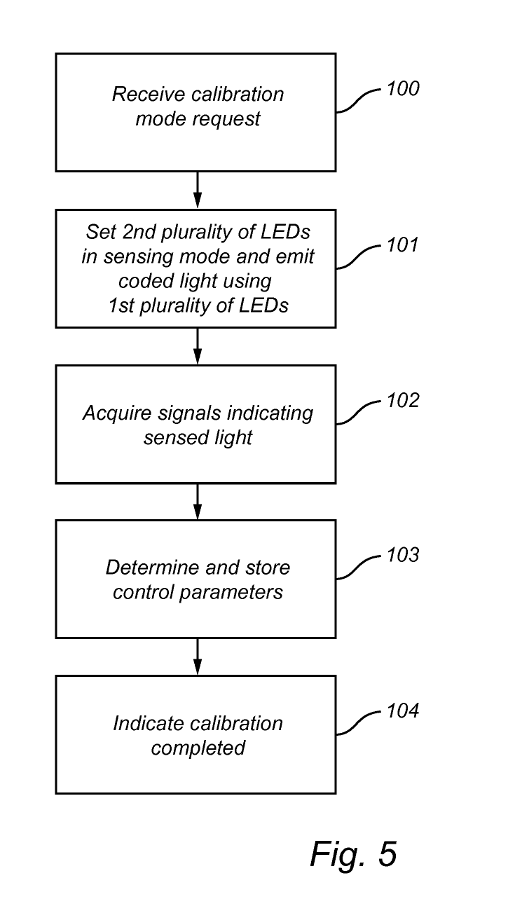

Finally, an exemplary method of controlling the light-emitting panel 1 in FIGS. 1-4 will be described below with reference to the flow-chart in FIG. 5. In normal operation, the light-sources 11a-d in the first plurality of light-sources and the light-sources 14a-b in the second plurality of light-sources are controlled to emit light according to control parameters stored in memory.

In a first step 100, the light-emitting panel 1 receives a calibration mode request.

In response to the calibration mode request, the control unit 30 of the light-emitting panel controls, in step 101, each of the light-sources 14a-b in the second plurality of light-sources to its light-sensing state, for example by applying a reversed voltage to the light-sources 14a-b, and controls the light-sources 11a-d in the first plurality of light-sources to emit light.

The light-sources 14a-b in the second plurality of light-sources may be controlled to their light-sensing states simultaneously or sequentially or in groups. Furthermore, the control may take place through a global change of the supply voltage and/or locally, for example following transmission of a command over the communication bus 37 shown in FIG. 4.

The light-sources 11a-d in the first plurality of light-sources may be controlled in such a way that the entire light-emitting panel 1 lights up at once, or one (or several) segment(s) 34a-e (referring to FIG. 4) at a time.

Subsequently, in step 102, a signal indicative of the sensed light is acquired from each of the light-sources 14a-b in the second plurality of light-sources. The acquisition may be done globally, through the communication bus 37 indicated in FIG. 4, or locally, using a control unit arranged to control one or several of the light-sources 14a-b in the second plurality of light-sources.

To facilitate discrimination of light originating from the light-sources 11a-d in the first plurality of light-sources from light originating from other sources, the light-sources 11a-d in the first plurality of light-sources may be controlled to emit modulated light, which may be coded to transmit a data signal that may be used as identifier of the light.

Based on the acquired signals, control parameters for the light-emitting panel 1 are determined and stored in memory in step 103. The control parameters may be determined using the processor 31 in the control unit 30 and stored in the central memory 32. Alternatively, the determining and storing may be distributed.

Finally, in step 104, the light-emitting panel 1 provides a signal indicating that calibration is completed. For example, the light-sources 11a-d in the first plurality of light-sources may be controlled to blink a given number of times and/or with a given blinking pattern.

Additionally, variations to the disclosed embodiments can be understood and effected by the skilled person in practicing the claimed invention, from a study of the drawings, the disclosure, and the appended claims. For example, the light-sources in the first light-source layer may be arranged on a printed circuit board, for instance a flexible circuit board. In embodiments with two light-source layers with a light-diffusing layer sandwiched therebetween, the light-sources in the second light-source layer may be arranged on an optically translucent substrate, such as a suitable flexible printed circuit board.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A light-emitting panel comprising:
a front side and a back side;
a first plurality of light-sources arranged in a first light-source layer and a second plurality of light-sources arranged in a second light-source layer, the first and second light source layers being arranged to emit light in a direction towards the front side;
a light-diffusing layer arranged and configured to substantially only diffuse light emitted by light-sources in the first plurality of light-sources so that the light-emitting panel is arranged to provide diffused illumination from the first light-source layer and substantially un-diffused illumination from the second light-source layer;
wherein the second light-source layer comprises a light-sensor for providing a signal based on the sensing of light emitted by light-sources in the first plurality of light-sources following reflection at an object arranged in front of the light-emitting panel, the light sensor being formed by at least a sub-set of the light-sources in the second plurality of light-sources that are controllable between a light-emitting state and a light-sensing state,
wherein the light-emitting panel further comprises control circuitry configured to control light-sources in the second plurality of light-sources between the light-emitting state and the light-sensing state, and to control operation of the light-emitting panel based on the signal provided by the light-sensor.

2. The light-emitting panel according to claim 1, wherein the first and second light source layers are separate layers of a stack, the second light-source layer being optically transparent for light emitted by the first plurality of light-sources, and wherein the light-diffusing layer is sandwiched between the first light-source layer and the second light-source layer.

3. The light-emitting panel according to claim 1, wherein each of the light-sources in the second plurality of light-sources is arranged in the first light-source layer; and wherein the light-diffusing layer is arranged and configured to exhibit a higher diffuser efficiency for light emitted by light-sources in the first plurality of light-sources than for light emitted by light-sources in the second plurality of light-sources.

4. The light-emitting panel according to claim 1, wherein the second light-source layer comprises a grid-shaped substrate; and wherein each of the light-sources in the second plurality of light-sources is connected to the grid-shaped substrate.

5. The light-emitting panel according to claim 4, wherein the grid-shaped substrate comprises a plurality of metal wires defining a grid with nodes; and wherein each of the light-sources in the second plurality of light-sources is arranged at a respective one of the nodes and electrically and mechanically connected to at least two of the plurality of metal wires.

6. The light-emitting panel according to claim 4, wherein the second light-source layer further comprises a transparent material embedding the grid-shaped substrate and the light-sources.

7. The light-emitting panel according to claim 1, wherein the light-emitting panel further comprises a base structure, and wherein the first plurality of light-sources is embedded in the base structure.

8. The light-emitting panel according to claim 7, wherein each light-source in the first plurality of light-sources is embedded in a light-diffusing material forming the light-diffusing layer.

9. The light-emitting panel according to claim 1, wherein each of the light-sources in the first plurality of light-sources has a lower luminous intensity than any of the light-sources in the second plurality of light-sources.

10. The light-emitting panel according to claim 1, wherein the light-emitting panel comprises a memory; and wherein the control circuitry is configured to:
control light-sources in the first plurality of light-sources to emit light;
acquire a signal indicative of sensed light;
determine control parameters for the light-emitting panel based on the signals; and
store the control parameters in the memory.

11. The light-emitting panel according to claim 10, wherein each light-source in the second set comprises control circuitry and memory.

12. The light-emitting panel according to claim 1, wherein the light-sources in the first plurality of light-sources are arranged to emit coded light.
